(19) United States
(12) Patent Application Publication
(10) Pub. No.: US 2025/0084326 A1
(43) Pub. Date: Mar. 13, 2025

(54) DOWNDRAFT PLASMA GASIFIER

(71) Applicant: Reformed Energy, Inc., Bellaire, TX (US)

(72) Inventor: Andrew Schlote, Fenton, MO (US)

(73) Assignee: Reformed Energy, Inc., Bellaire, TX (US)

(21) Appl. No.: 18/826,866

(22) Filed: Sep. 6, 2024

Related U.S. Application Data
(60) Provisional application No. 63/581,111, filed on Sep. 7, 2023.

(51) Int. Cl. C10J 3/66; B01D 46/28; C10B 49/06; C10B 51/00; C10B 57/00

(52) U.S. Cl. CPC C10J 3/66; B01D 46/28; C10B 49/06; C10B 51/00; C10B 57/005; B01D 2273/20; C10J 2200/09; C10J 2200/158

(57) ABSTRACT

A gasifier system configured to generate synthesis gas via thermal decomposition of materials at elevated temperatures in an oxygen deprived atmosphere via pyrolysis is disclosed. The gasifier may include numerous subsystems configured to increase the operational efficiency of the gasifier. For example, and not by means of limitation, the gasifier may include a syngas recirculation system, a screenless ash removal system, a tar reduction system, a negative slope gasifier system and a syngas catalyzer system. The syngas recirculation system may increase efficiency of the gasifier system.

### CROSS-REFERENCE TO RELATED APPLICATION

The patent application claims the benefit of U.S. Provisional Patent Application No. 63/581,111, filed Sep. 7, 2023, which is incorporated by reference in its entirety.

### BACKGROUND

The disclosure relates generally to gasifier systems, and more particularly, to gasification systems capable of using waste products as fuel to form clean synthesis gas (syngas) that is useful for power generation.

Gasifiers use pyrolysis to convert feedstock to syngas, heat and by products. The syngas has been used to power engines for a number of applications. Conventional gasifiers have been used for decades and while are beneficial in the production of syngas, produce many undesirable byproducts, such as tar and other materials. Gasifiers also require oversight to deal with feedstock stoppages within the gasifier chambers caused by inconsistent processing of the feedstock and development of worm holes in the feedstock in the gasifier chambers, which slows processing time. Thus, a need exists for a more efficient gasifier.

### SUMMARY

A gasifier system configured to generate synthesis gas (hereinafter “syngas”) via thermal decomposition of materials at elevated temperatures in an oxygen deprived atmosphere via pyrolysis is disclosed. The gasifier may include numerous subsystems configured to increase the operational efficiency of the gasifier. For example, and not by means of limitation, the gasifier may include a syngas recirculation system, a screenless ash removal system, a tar reduction system, a negative slope gasifier system and a syngas catalyzer system. The syngas recirculation system may increase efficiency of the gasifier system.

In at least one embodiment, the gasifier system may include one or more gasifier chambers configured to receive feedstock and convert the feedstock, at least in part, to syngas via pyrolysis. The gasifier system may include a syngas recirculation system configured to receive at least a portion of the syngas formed within the gasifier system through an inlet in a tube near a bottom of the gasifier chamber and pass the syngas upstream of a fuel pile positioned within the gasifier chamber. The tube of the syngas recirculation system may be positioned in a center of the gasifier chamber and may extend from the bottom of the gasifier chamber to a top of the fuel pile upstream of the fuel pile. The tube of the syngas recirculation system may be positioned in the middle of the gasifier chamber for recirculation.

The gasifier system may include a blower in communication with the tube to generate flow and increased static pressure in order to force a portion of the syngas into the fuel pile. The gasifier system may include a flow spinning device located inside the tube and near the blower to cause a rotational motion in the flow which forces carbon and ash particles to be blown by the blower into the top of the fuel pile, where the carbon is converted into carbon monoxide and the ash particles act as a catalyzing agent. The tube may include an entrance section positioned at the bottom of the tube and extend above a throat area, wherein the entrance section of the tube is formed from a nickel superalloy.

The gasifier system may include one or more integral heat exchangers for air preheat. The gasifier system may include a syngas catalyzer system configured to bypass syngas through ash such that the minerals in the ash catalyze syngas and increase the production of methane within the gasifier system. The gasifier system may include a plurality of flowpaths to utilize ash that develops in the gasifier system, whereby a first path mixes syngas ash downstream of a throat as it progresses towards and through a brush filter and a second path is a leakage path of the syngas through the brush filter, up the center tube and through a blower where it is blown into the top of the fuel pile.

The gasifier system may include a screenless ash removal system that incorporates the brush filter separating ash from syngas and functions as an ash catalyst and filter. The gasifier system may include a vibratory ash guide positioned downstream of a throat in the gasifier chamber to direct ash into the desired spot. The gasifier system may include a tar reduction system configured to reduce tar from the syngas within the gasifier chamber. The tar reduction system is formed from an electric arc, thermoplasma injection device configured to generate a jet formed at least partially of fuel which is ignitable by a high voltage electrical plasma to provide a high temperature thermal jet capable of reducing tar.

The gasifier system may include a tar reduction system formed from an electric arc, thermoplasma injection device configured to generate a jet formed at least partially of fuel which is ignitable by a high voltage electrical plasma to provide a high temperature thermal jet capable of reducing tar. The tar reduction system may include one or more torches formed from a standard plasma cutter device configured to use a non-transferred arc design with an anode contained within the at least one torch.

The gasifier system may include a negative slope gasifier system in which the gasifier chamber includes a negative slope from throat to the top of the pile of downdraft gasifier that prevents bridging and allows all of the fuel pile to travel downward at a similar rate.

An advantage of the gasifier system is that the syngas recirculation system may increase efficiency of the system by transferring heat from the syngas to preheat the fuel pile.

Another advantage of the gasifier system is that the syngas recirculation system may increase efficiency of the system by boiling water contained in the fuel pile to create steam.

Yet another advantage of the gasifier system is that the syngas recirculation system may increase efficiency of the system by volatilizing a large portion of the light hydrocarbons contained within the fuel.

Another advantage of the gasifier system is that the syngas recirculation system may increase efficiency of the system by allowing control of superficial velocity in order to increase the reaction rate of the fuel pile.

Still another advantage of the gasifier system is that the syngas recirculation system may increase efficiency of the system by allowing conversion of carbon dust that was preferentially separated by its path through the blower.

Another advantage of the gasifier system is that the syngas recirculation system may increase efficiency of the system by taking advantage of the catalytic action of the ash that was carried up through the tube and was preferentially separated by the blower and blown into the top of the fuel pile.

Yet another advantage of the gasifier system is that the syngas recirculation system may increase efficiency of the system by allowing pressurized air/oxygen to be fed from the exterior of the gasifier chamber to the throat area to be injected from the ID of the fuel pile toward the OD of the fuel pile.

Another advantage of the gasifier system is that the syngas recirculation system may increase efficiency of the system by allowing heat exchange from the ash area and syngas heat to be used to preheat the combustion air.

Still another advantage of the gasifier system is that the syngas recirculation system may increase efficiency of the system by allowing balance control of combustion air to be optimized between the air/oxygen injected from the fuel pile OD injected radially inward, and the tube air/oxygen injected from the fuel pile ID radially outward.

These and other embodiments are described in more detail below.

### BRIEF DESCRIPTION OF THE DRAWINGS

FIG. 1 is a perspective view of the gasifier system.

FIG. 2 is a cross-sectional, front view of the gasifier system taken at section line 2-2 in FIG. 1.

FIG. 3 is a schematic front view of the gasifier system.

FIG. 4 is a cross-sectional, detail view of the vibratory ash guide of the gasifier and related systems taken at detail 4 in FIG. 2.

FIG. 5 is a cross-sectional view of the gasifier system showing the ash auger taken at section line 5-5 in FIG. 1.

FIG. 6 is a top view of the gasifier system.

FIG. 7 is a perspective view of an ash auger of the gasifier system.

FIG. 8 is a schematic view of the syngas recirculation flow within the gasifier system.

FIG. 9 is a perspective view of a torch of the gasifier system.

FIG. 10 is a cross-sectional view of the torch of the gasifier system taken at section line 10-10 in FIG. 9.

### DETAILED DESCRIPTION

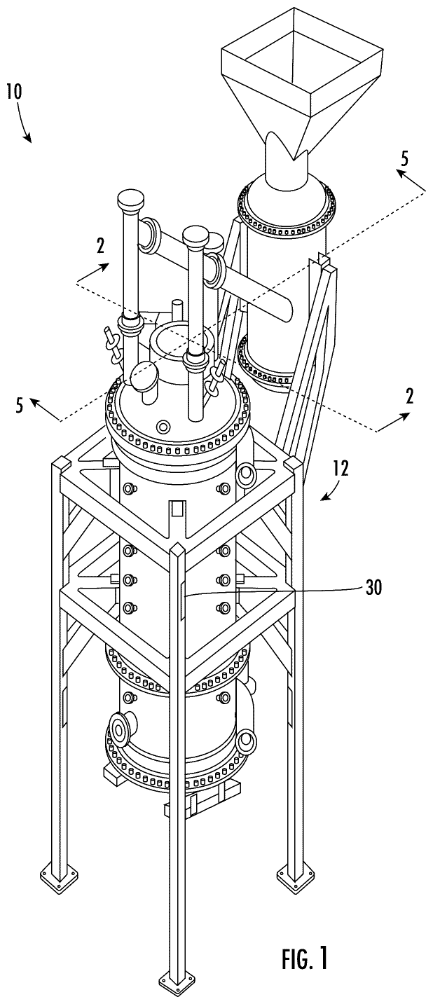

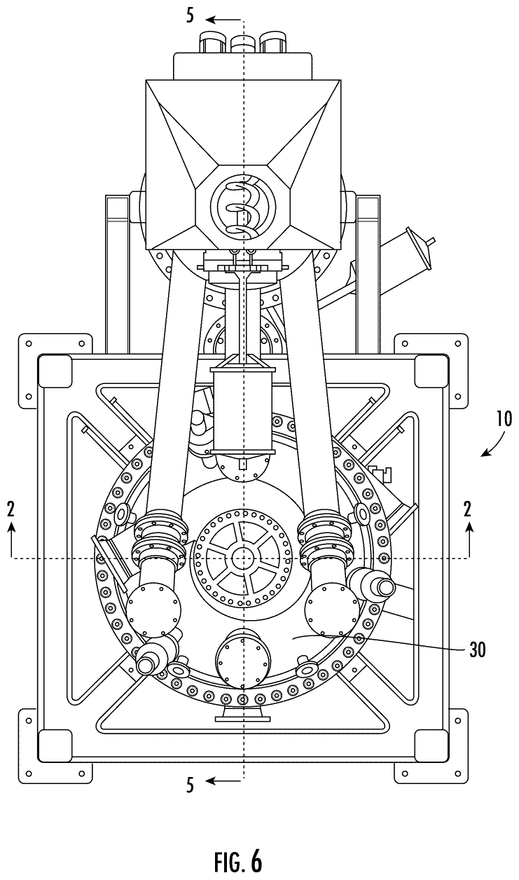

As shown in FIGS. 1-11, a gasifier system 10 configured to generate synthesis gas (hereinafter “syngas”) via thermal decomposition of materials at elevated temperatures in an oxygen deprived atmosphere via pyrolysis is disclosed. The gasifier 10 includes numerous subsystems configured to increase the operational efficiency of the gasifier 10. For example, and not by means of limitation, the gasifier 10 may include a syngas recirculation system 12, a screenless ash removal system 14, a tar reduction system 16, a negative slope gasifier system 18 and a syngas catalyzer system 20.

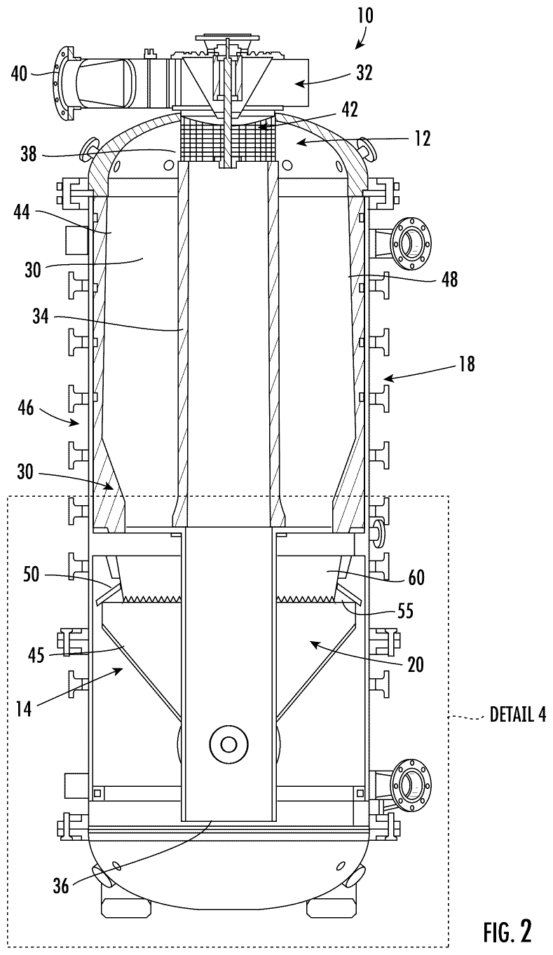

As shown in FIG. 2, the syngas recirculation system 12 may be configured to recirculate heated syngas within the gasifier chamber 30 to increase efficiency of the gasifier system 10. The syngas recirculation system 12 may include a blower 32 at the top of the gasifier chamber 30 for syngas recirculation. The blower 32 may be located at the top of the gasifier chamber 30 with an open bottom and open top. The blower 32 may be powered by a hydraulic motor for safety. The syngas recirculation system 12 may be configured such that syngas enters a center tube 34 through an inlet 36 positioned near a bottom of the gasifier chamber 30. The syngas recirculation system 12 may include outlets 38 near the top of the fuel pile 22 within the gasifier chamber 30 and an outlet at a diffuser and gasifier exhaust 40. The spinning blower 32 may generate flow and increased static pressure in order to force a portion of the syngas into the fuel pile 22 to accomplish the following:
i) transfer heat from the syngas to preheat the fuel pile 22;
ii) boil water contained in the fuel pile 22 to create steam;
iii) volatilize a large portion of the light hydrocarbons contained within the fuel 22;
iv) allow control of superficial velocity in order to increase the reaction rate of the fuel pile 22;
v) allow conversion of carbon dust that was preferentially separated by its path through the blower;
vi) take advantage of the catalytic action of the ash that was carried up through the tube and was preferentially separated by the blower 32 and blown into the top of the fuel pile 22.

The syngas recirculation system 12 may include one or more tubes 34 positioned in the gasifier chamber 30 to direct syngas from near the bottom of the gasifier chamber 30 to the top of the fuel pile 22. In at least one embodiment, the tube 34 may be positioned in the center of the gasifier chamber 30 and extend from the bottom of the gasifier chamber 30 to the top of the fuel pile 22. The tube 34 may be positioned in the middle of the gasifier chamber 30 for recirculation. The tube 34 may be located in the center of the fuel pile 22 and extends below the ash removal area. The tube 34 may be fabricated using materials such as, but not limited to, ceramic, metal and the like. A flow spinning device 42, as shown in FIG. 2, may be located inside the tube 34 and near the blower in order to cause a rotational motion in the flow which forces carbon and ash particles to be blown by the blower 32 into the top of the fuel pile 22, where the carbon is converted into carbon monoxide and the ash acts as a catalyzing agent when it reaches the throat area. The section of the tube 34 from the bottom of the tube 34 to the throat area may be constructed using a material such as, but not limited to, a nickel superalloy with the following benefits:
i) allowing pressurized air/oxygen to be fed from the exterior of the gasifier chamber 30 to the throat area to be injected from the ID of the fuel pile 22 toward the OD of the fuel pile 22;
ii) allowing heat exchange from the ash area and syngas heat to be used to preheat the combustion air;
iii) allowing balance control of combustion air to be optimized between the air/oxygen injected from the fuel pile OD injected radially inward, and the tube air/oxygen injected from the fuel pile ID radially outward.

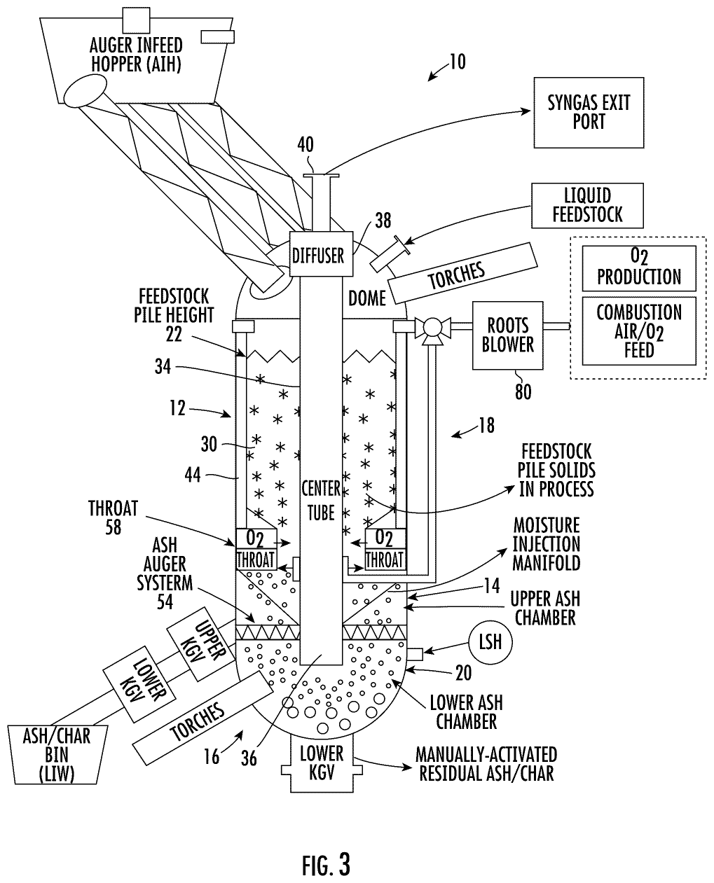

The gasifier system 10 may also include one or more integral heat exchangers 44 for air preheat with balance valve. Air exhausted from the heat exchanger 44 may be configured for inside toward outside flow or outside toward inside flow, or both. In particular, the heat exchanger 44 may be configured to provide air or oxygen, or both, which may be pressurized by a roots blower 80, as shown in FIG. 3, and divided by balance valves with a portion injected at the top of the gasifier chamber 30 between the outer shell 46 and the inner liner 48 where it picks up heat from the inner liner and is then injected radially inward at the throat of the fuel pile 22 for outside toward inside flow, and another portion may be injected near the bottom of the gasifier chamber 30 where it picks up heat from the syngas and from the ash to be injected radially outward into the fuel pile 22 for inside toward outside flow.

The gasifier system 10 may include a syngas catalyzer system 20, as shown in FIGS. 2, 3, 4 and 5, configured to catalyze syngas. In at least one embodiment, the syngas catalyzer system 20 is configured to pass syngas through ash captured in the ash trough 45 such that the minerals in the ash, especially forms of potassium, such as KOH, when present with sufficient moisture and temperature, catalyze syngas and increase the production of methane within the gasifier system 10. The ash is mainly removed by the ash auger 54, as shown in FIG. 3. A small portion of the ash is carried through the brush filter 50 and is allowed to recirculate through the tube 34. All or nearly all of the syngas flows through the brush filters 50. The high flow creates flow channels which allow optimal exposure of the syngas to the catalyzing ash.

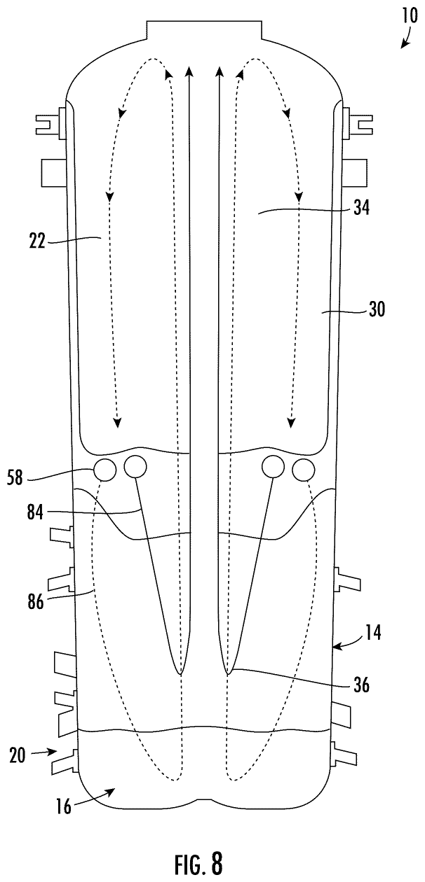

In at least one embodiment, the gasifier system 10 may include one or more flow paths through ash contained within the gasifier system 10. In at least one embodiment, as shown in FIG. 8, the gasifier system 10 may include a dual flowpath to utilize ash that has been developed in this gasifier. The first path 84 mixes syngas ash downstream of the throat as it progresses towards and through a brush filter 50. The second path 86 may be a leakage path of the syngas through the brush filter 50, up the center tube 34, through the flow rotator and through the blower 32 where it is blown into the top of the fuel pile 22. Once on the top of the fuel pile 22, the syngas may travel toward the throat area 58 and can drive catalytic reactions anywhere conditions are right.

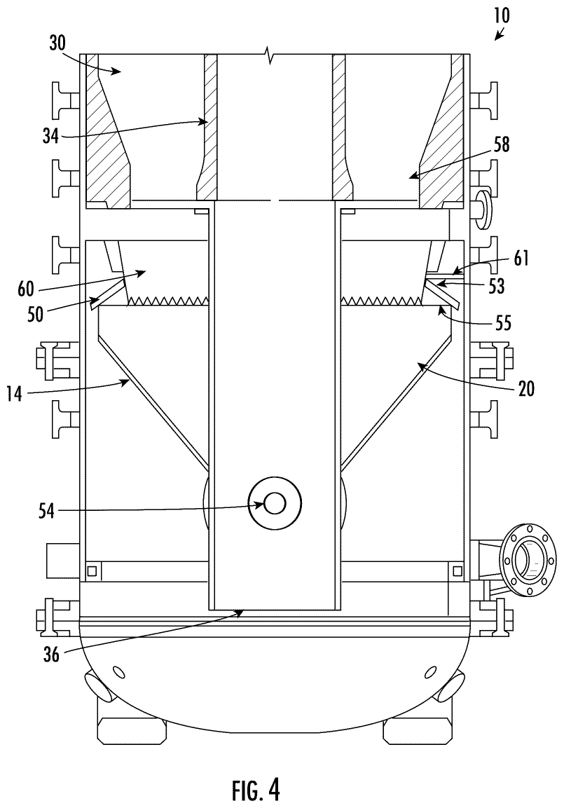

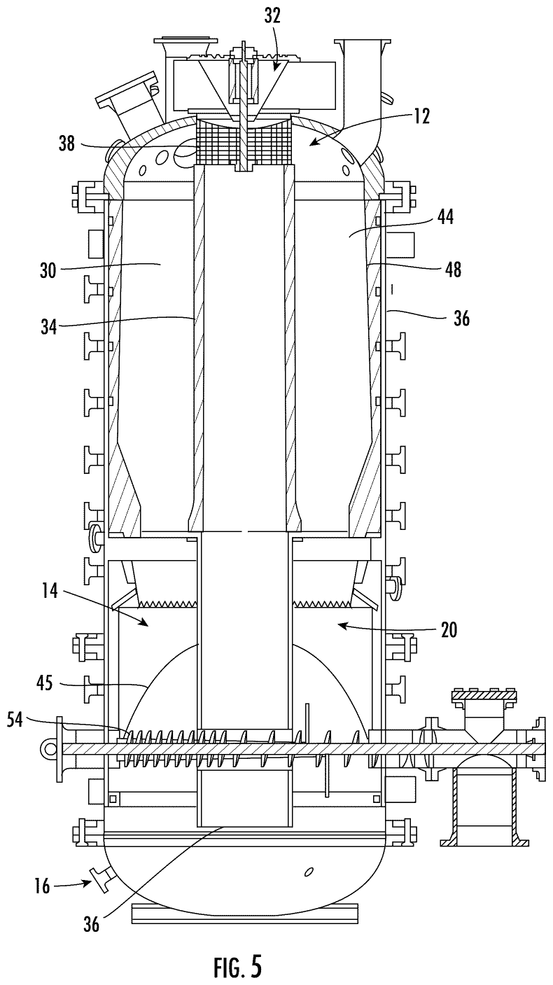

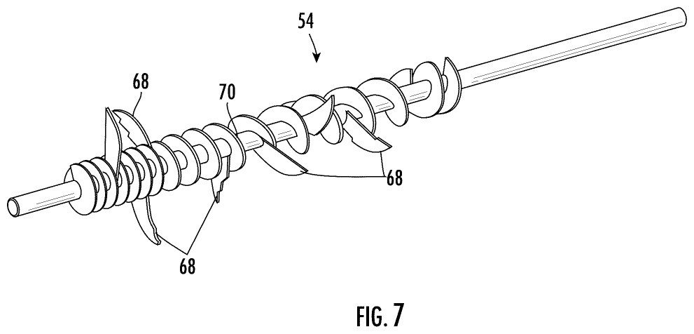

The gasifier system 10 may include a screenless ash removal system 14, as shown in FIG. 4. The screenless ash removal system 14 eliminates problems that are often found in gasifier applications in which screens routinely clog or have carbon bind to them and cause other issues. The screenless ash removal system 14 of the gasifier system 10 eliminates all screens from the gasifier and incorporates a brush filter 50 fabricated using materials, such as, but not limited to metal, such as inconel (such as 625), that may be similar in appearance to a paint brush. The bristles are supported on one side by a rail 53, with the other side resting on a metal ledge 55. The flow path is designed to allow the syngas to travel a path that allows it to stir up and carry some of the ash toward the brush filter 50. The brush filter 50 separates the ash from the syngas and only allows a small portion through the brush filter 50. The bulk of the ash captured by the brush filter 50 travels down a chute to an auger 54 for removal. The auger 54, as shown in FIGS. 5 and 7, may be designed with a variable pitch to accomplish uniform ash removal from the gasifier chamber 30. The ash auger 54 may include one or more claws 68 extending radially from the auger shaft 70. The shaft 70 may include an auger extending radially therefrom and forming a helical shape along a length of the shaft 70. The one or more claws 68 may extending radially from the shaft 70 further than the auger. The claws 68 may include one or more teeth or disruption edges 72 configured to breakup the ash.

The gasifier system 10 may include a vibratory ash guide 60, as shown in FIG. 4, for trouble-free operation. The vibratory ash guide 60 may be located just downstream of the throat. The vibratory ash guide 60 may direct ash into the desired spot. The main brush filter 50 may be attached to the vibratory ash guide 60, which allows vibrational cleaning of the brush filter 50. Additionally, the vibratory ash guide 60 can help break up any upstream material bridging and ensure uniform downward flow of the fuel pile 22. The vibratory ash guide 60 may be formed from materials, such as, but not limited to, metals, such as inconel. The vibratory ash guide 60 may be formed from a generally converging shape. Such shape may cause the ash to pack and distort flow. To alleviate this risk, the vibratory ash guide 60 may include a yoke 61 and vibrating motor assembly attached to the guide 60. The brush filter 50 may also be attached to the ash guide. Energizing the vibratory motor frees up any blockage as well as cleans the brush 54 of any blockage. The vibratory ash guide 60 may also function as an auto cleaning brush filter.

The gasifier system 10 may include an ash catalyst and filter, as set forth in the screenless ash removal system 14 and vibratory ash guide 60. The screenless ash removal system 14 and vibratory ash guide 60 with the one or more brush filters 50 may also function as an ash filter in the gasifier system 10.

The gasifier system 10 may include an ash filter cleaner 62, as shown in FIG. 4. In the event that extra cleaning of the brush filter is required, an ash filter cleaner 62 may include a brush mount rail configured to receive a pressurized flow of nitrogen to clean the brush filter 50. The pressurized flow of nitrogen may travel axially with the brush filter bristles and force any clog out of the brush filter 50 and exit the end of the brush filter 50.

The gasifier system 10 may include a tar reduction system 16, as shown in FIG. 5, configured to reduce tar from the syngas within the gasifier chamber 30. The tar reduction system 16 may include an electric arc/thermo plasma injection device. In at least one embodiment, the thermal plasma may use a jet of oxygen and/or air mixed with fuel which is ignited by a high voltage electrical plasma to provide a high temperature thermal jet capable of reducing tar and/or starting the gasifier system 10. The tar reduction system 16 may be formed from an electric arc, thermoplasma injection device configured to generate a jet formed at least partially of fuel which is ignitable by a high voltage electrical plasma to provide a high temperature thermal jet capable of reducing tar. The tar reduction system 16 may include at least one torch 56 formed from a standard plasma cutter device configured to use a non-transferred arc design with an anode contained within the at least one torch 56.

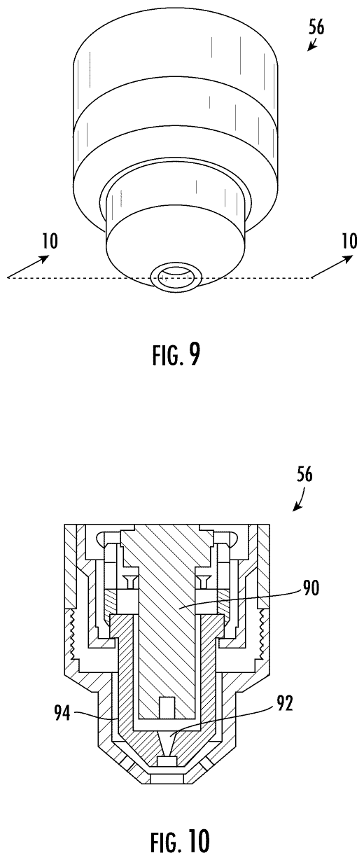

In another embodiment, the tar reduction system 16 may alternatively include one or more torches 56, as shown in FIGS. 9 and 10, formed from a standard plasma cutter device, which is designed to use a transferred arc in its operation. The at least one torch 56, as shown in FIG. 10, may include an electrode 90, a nozzle 92 and shield gas conduit 94. In order to use it within the gasifier where there is no practical metallic anode, the torch 56 may be first converted to a non-transferred arc design. Non-transferred Arc designs have an anode contained within the torch 56, which generates enormous amounts of heat at the anode that severely limits life and thus needs a large amount of cooling fluid. The tar reduction system 16 may incorporate a porous silicon carbide, a porous metal anode, or the like, which is transpiration cooled. Such configuration of the torch 56 in the tar reduction system 16 decreases anode heat by about 95% and allows the torch 56 to stay cool with only a small flow of nitrogen, such as less than 10 cubic feet per hour, as opposed to upwards of 30 cubic feet per minute flow required for the conventional system.

The gasifier system 10 may also include a negative slope gasifier system 18. As such, the gasifier chamber 30 may include a negative slope from throat to the top of the pile of downdraft gasifier. Gasifiers designed with straight walls suffer detrimental bridging effects, which in turn cause worm holes, uneven fuel feed, very low calorific syngas and failure of the gasifier. The negative slope gasifier system 18 has a negative slope in the fuel pile gasifier structure that prevents bridging and allows the entire pile to travel downward at a similar rate. Such unrestricted flow and bridge prevention is due to the circumference of the wall defining the fuel pile 22 becoming larger as the fuel travels downstream, thereby eliminating the path for a packing force to cause bridging. In at least one embodiment, the wall defining the fuel pile 22 containment may be formed from a material, such as, but not limited to ceramic.

In at least one embodiment, the negative slope gasifier system 18 may include a slope moving from top to bottom in which a diameter of an inner surface of the gasifier chamber 30 increases at an angle of up to 7.5 degrees from vertical. In at least one embodiment, the diameter of an inner surface of the gasifier chamber 30 increases between at an angle up to two degrees from vertical. In at least one embodiment, the diameter of an inner surface of the gasifier chamber 30 increases between at an angle between one 1.5 degrees and two degrees from vertical. The inner surface of the gasifier chamber 30 forming the negative slope gasifier system 18 may have any appropriate length, such as, but not limited to between two feet and 20 feet. In at least one embodiment, the inner surface of the gasifier chamber 30 forming the negative slope gasifier system 18 may have ae length between three feet and five feet.

During use, the gasifier system 10 may be used to create syngas via thermal decomposition of materials, such as, but not limited to feedstock, at elevated temperatures in an oxygen deprived atmosphere via pyrolysis. The feedstock may be, but is not limited to being, rubbish, commercial and residential garbage, landfill materials, wood, vegetation, tires, oils and other materials. A method of using the gasifier system may include providing feedstock to a gasifier system 10, whereby the gasifier system 10 includes one or more of the systems previously disclosed herein. For example and not by way if limitations, the method of using the gasifier system may include providing feedstock to a gasifier system 10, whereby the gasifier system 10 includes a gasifier chamber 30 configured to receive feedstock and convert the feedstock at least in part to syngas via pyrolysis, and a syngas recirculation system 12 configured to receive at least a portion of the syngas formed within the gasifier system 10 through an inlet 36 in a tube 34 near a bottom of the gasifier chamber 30 and pass the syngas upstream of a fuel pile 22 positioned within the gasifier chamber 30. The method may include starting pyrolysis in the gasifier chamber 30, such as via an electric arc/thermoplasma injection device, one or more torches, and other methods and devices. The feedstock may be provided to the gasifier chamber 30 via one or more infeed ports which may be, but are not limited to being, upstream from a gasifier throat. The feedstock may accumulate in the gasifier chamber 30 above the gasifier throat. As the feedstock falls via gravity in the gasifier throat, the inner diameter increases, which is the negative slope gasifier system 18 that prevents formation of uneven fuel feed. The feedstock is heated with the integral heat exchanger 44. The feedstock undergoes pyrolysis in the gasifier chamber 30 which creates syngas that is collected and exported from the gasifier chamber 30. The syngas may be used in a number of applications, such as, but not limited to, fueling an engine coupled to a generator to produce electric power.

The foregoing is provided for purposes of illustrating, explaining, and describing embodiments of the disclosed devices.

I claim:

1. A gasifier system, comprising:
a gasifier chamber configured to receive feedstock and convert the feedstock at least in part to syngas via pyrolysis; and
a syngas recirculation system configured to receive at least a portion of the syngas formed within the gasifier system through an inlet in a tube near a bottom of the gasifier chamber and pass the syngas upstream of a fuel pile positioned within the gasifier chamber.

2. The gasifier system of claim 1, wherein the tube of the syngas recirculation system is positioned in a center of the gasifier chamber and extends from the bottom of the gasifier chamber to a top of the fuel pile upstream of the fuel pile.

3. The gasifier system of claim 1, wherein the tube of the syngas recirculation system is positioned in a middle of the gasifier chamber for recirculation.

4. The gasifier system of claim 1, further comprising a blower in communication with the tube to generate flow and increased static pressure in order to force a portion of the syngas into the fuel pile.

5. The gasifier system of claim 4, further comprising a flow spinning device located inside the tube and near the blower to cause a rotational motion in the flow which forces carbon and ash particles to be blown by the blower into the top of the fuel pile, where the carbon is converted into carbon monoxide and the ash particles act as a catalyzing agent.

6. The gasifier system of claim 1, wherein the tube comprises an entrance section positioned at the bottom of the tube and extending above a throat area, wherein the entrance section of the tube is formed from a nickel superalloy.

7. The gasifier system of claim 1, further comprising at least one integral heat exchangers for air preheat.

8. The gasifier system of claim 1, further comprising a syngas catalyzer system configured to bypass syngas through ash such that the minerals in the ash catalyze syngas and increase the production of methane within the gasifier system.

9. The gasifier system of claim 1, further comprising a plurality of flowpaths to utilize ash has been developed in the gasifier system, whereby a first path mixes syngas ash downstream of a throat as it progresses towards and through a brush filter and a second path is a leakage path of the syngas through the brush filter, up the center tube and through a blower where it is blown into the top of the fuel pile.

10. The gasifier system of claim 1, further comprising a screenless ash removal system that incorporates a small brush separating ash from syngas and functions as an ash catalyst and filter.

11. The gasifier system of claim 1, further comprising a vibratory ash guide positioned downstream of a throat in the gasifier chamber to direct ash into the desired spot.

12. The gasifier system of claim 1, further comprising at least one ash auger comprising as least one shaft with an auger thereon and at least one claw extending radially outward further than the auger.

13. The gasifier system of claim 1, further comprising a tar reduction system configured to reduce tar from the syngas within the gasifier chamber.

14. The gasifier system of claim 13, wherein the tar reduction system is formed from an electric arc, thermoplasma injection device configured to generate a jet formed at least partially of fuel which is ignitable by a high voltage electrical plasma to provide a high temperature thermal jet capable of reducing tar.

15. The gasifier system of claim 13, wherein the tar reduction system includes at least one torch formed from a standard plasma cutter device configured to use a non-transferred arc design with an anode contained within the at least one torch.

16. The gasifier system of claim 1, further comprising a negative slope gasifier system in which the gasifier chamber includes a negative slope from throat to the top of the pile of downdraft gasifier that prevents bridging and allows all of the fuel pile to travel downward at a similar rate.

17. A gasifier system, comprising:
a gasifier chamber configured to receive feedstock and convert the feedstock at least in part to syngas via pyrolysis;
a syngas recirculation system configured to receive at least a portion of the syngas formed within the gasifier system through an inlet in a tube near a bottom of the gasifier chamber and pass the syngas upstream of a fuel pile positioned within the gasifier chamber;
a blower in communication with the tube to generate flow and increased static pressure in order to force a portion of the syngas into the fuel pile; and
at least one integral heat exchangers for air preheat.

18. The gasifier system of claim 17, further comprising a flow spinning device located inside the tube and near the blower to cause a rotational motion in the flow which forces carbon and ash particles to be blown by the blower into the top of the fuel pile, where the carbon is converted into carbon monoxide and the ash particles act as a catalyzing agent.

19. The gasifier system of claim 17, further comprising at least one integral heat exchangers for air preheat.

20. The gasifier system of claim 17, further comprising a syngas catalyzer system configured to catalyze syngas bypass syngas through ash such that the minerals in the ash catalyze syngas and increase the production of methane within the gasifier system.

21. The gasifier system of claim 17, further comprising a plurality of flowpaths to utilize ash has been developed in the gasifier system, whereby a first path mixes syngas ash downstream of a throat as it progresses towards and through a brush filter and a second path is a leakage path of the syngas through the brush filter, up the center tube and through a blower where it is blown into the top of the fuel pile.

22. The gasifier system of claim 17, further comprising a screenless ash removal system that incorporates a small brush separating ash from syngas and functions as an ash catalyst and filter.

23. The gasifier system of claim 17, further comprising a vibratory ash guide positioned downstream of a throat in the gasifier chamber to direct ash into the desired spot.

24. The gasifier system of claim 17, further comprising at least one ash auger comprising as least one shaft with an auger thereon and at least one claw extending radially outward further than the auger.

25. The gasifier system of claim 17, further comprising a tar reduction system configured to reduce tar from the syngas within the gasifier chamber.

26. The gasifier system of claim 17, further comprising a negative slope gasifier system in which the gasifier chamber includes a negative slope from throat to the top of the pile of downdraft gasifier that prevents bridging and allows all of the fuel pile to travel downward at a similar rate.

27. A method of generating syngas via a gasifier system, comprising:
providing feedstock to a gasifier system, the gasifier system comprising:
a gasifier chamber configured to receive feedstock and convert the feedstock at least in part to syngas via pyrolysis; and
a syngas recirculation system configured to receive at least a portion of the syngas formed within the gasifier system through an inlet in a tube near a bottom of the gasifier chamber and pass the syngas upstream of a fuel pile positioned within the gasifier chamber; and
starting pyrolysis in the gasifier chamber.

28. The method of claim 27, wherein providing feedstock to the gasifier system further comprises the gasifier system including a blower in communication with the tube to generate flow and increased static pressure in order to force a portion of the syngas into the fuel pile.

29. The method of claim 27, wherein providing feedstock to the gasifier system further comprises the gasifier system including a flow spinning device located inside the tube and near the blower to cause a rotational motion in the flow which forces carbon and ash particles to be blown by the blower into the top of the fuel pile, where the carbon is converted into carbon monoxide and the ash particles act as a catalyzing agent.

30. The method of claim 27, wherein providing feedstock to the gasifier system further comprises the gasifier system including at least one integral heat exchangers for air preheat.

31. The method of claim 27, wherein providing feedstock to the gasifier system further comprises the gasifier system including a syngas catalyzer system configured to catalyze syngas bypass syngas through ash such that the minerals in the ash catalyze syngas and increase the production of methane within the gasifier system.

32. The method of claim 27, wherein providing feedstock to the gasifier system further comprises the gasifier system including a plurality of flowpaths to utilize ash has been developed in the gasifier system, whereby a first path mixes syngas ash downstream of a throat as it progresses towards and through a brush filter and a second path is a leakage path of the syngas through the brush filter, up the center tube and through a blower where it is blown into the top of the fuel pile.

33. The method of claim 27, wherein providing feedstock to the gasifier system further comprises the gasifier system including a screenless ash removal system that incorporates a small brush separating ash from syngas and functions as an ash catalyst and filter.

34. The method of claim 27, wherein providing feedstock to the gasifier system further comprises the gasifier system including a vibratory ash guide positioned downstream of a throat in the gasifier chamber to direct ash into the desired spot.

35. The method of claim 27, wherein providing feedstock to the gasifier system further comprises the gasifier system including a tar reduction system configured to reduce tar from the syngas within the gasifier chamber.

36. The method of claim 27, wherein providing feedstock to the gasifier system further comprises the gasifier system including a negative slope gasifier system in which the gasifier chamber includes a negative slope from throat to the top of the pile of downdraft gasifier that prevents bridging and allows all of the fuel pile to travel downward at a similar rate.
